(19) United States
(12) Patent Application Publication
(10) Pub. No.: US 2014/0300827 A1
(43) Pub. Date: Oct. 9, 2014

(54) MOBILE DEVICE AND REMOTE CONTROL CONNECTION FOR ELECTRONIC DEVICE VIA NEAR FIELD COMMUNICATION

(71) Applicant: MediaTek Singapore Pte. Ltd., Singapore (SG)

(72) Inventors: Itamar Gold-Gavriely, Sunnyvale, CA (US); Huanchun Ye, Cupertino, CA (US)

(21) Appl. No.: 14/346,969

(22) PCT Filed: Dec. 13, 2012
(86) PCT No.: PCT/SG2012/000472

§ 371 Date: Mar. 25, 2014

Related U.S. Application Data
(60) Provisional application No. 61/608,648, filed on Mar. 9, 2012.

(51) Int. Cl. H04N 5/44; H04B 5/00

(52) U.S. Cl. CPC H04N 5/44; H04B 5/0031
USPC 348/734

(57) ABSTRACT

A remote control for an electronic device having near field communication capability communicates with a mobile device having near field communication capability, for initiating information exchange between the electronic device and the mobile device. The electronic device may be a digital television, the remote control may be an infra-red, Bluetooth or Wi-Fi remote control, and the mobile device may be a smart phone or a tablet.

### BACKGROUND OF THE INVENTION

1. Field of the Invention

The invention relates to digital televisions with network capability that can pass information between the television and a mobile device utilizing near field communication between the mobile device and a dedicated remote control of the digital television.

2. Description of the Prior Art

In the past decade, the functions of electronic devices have increased dramatically. With the advent of 3G technology, personal electronic devices such as mobile phones or tablets can be provided with Internet capability, and revolutions in the digital field mean the humble television set can be utilized for anything from home shopping to video conferencing.

Many functions of a standard digital television can be tailored to a specific user. For instant messaging or video conferencing functions, for example, each user will have an individual profile as well as an individual list of contacts. As a digital television is often used by many members of a household, each time a user wishes to access the instant messaging or video conferencing functions, they will have to go through a number of authenticating steps in order to locate their individual profile. For the home shopping example provided above, safety issues may come into play if a user's credit card details are stored in the memory of the digital television.

It is therefore not possible to configure the television for an individual user without having to go through a number of authenticating steps. The invention seeks to solve this problem by introducing a more direct way of utilizing the digital television's capabilities.

### SUMMARY OF THE INVENTION

A dedicated remote control for a digital television with near field communication capability communicates with a mobile device with near communication capability, for exchanging information between the digital television, the mobile phone, and a network application.

### BRIEF DESCRIPTION OF THE DRAWINGS

FIG. 1 is a diagram showing the communication between a digital television, a network server, a remote control and a mobile device according to an exemplary embodiment of the present invention.

FIG. 2 is a flowchart detailing steps of a method for transmitting information from the mobile device to the digital television illustrated in FIG. 1.

FIG. 3 is a flowchart detailing steps of a method for transmitting information from the digital television to the mobile device illustrated in FIG. 1.

FIG. 4 is a flowchart detailing steps of a method for transmitting information from the mobile device to network application per TV content illustrated in FIG. 1.

### DETAILED DESCRIPTION

The current disclosure introduces a system wherein a mobile device can be used to directly communicate with a digital television via a dedicated remote control of the digital television in order to provide instant authentication and a more user friendly experience.

As a mobile device such as a mobile phone or tablet is individual to a particular user, the use of the mobile device to access the digital television allows customization of the digital television and enables a session to be tailored to a particular user. Information stored on a mobile device can be directly transmitted to the digital television and vice versa. Determination of a user's identity can also be directly authenticated by using the mobile device to communicate with the digital television.

The following will describe an exemplary system for performing the above operations, as well as detailing a number of exemplary processes whereby information is transmitted between a mobile device and a digital television.

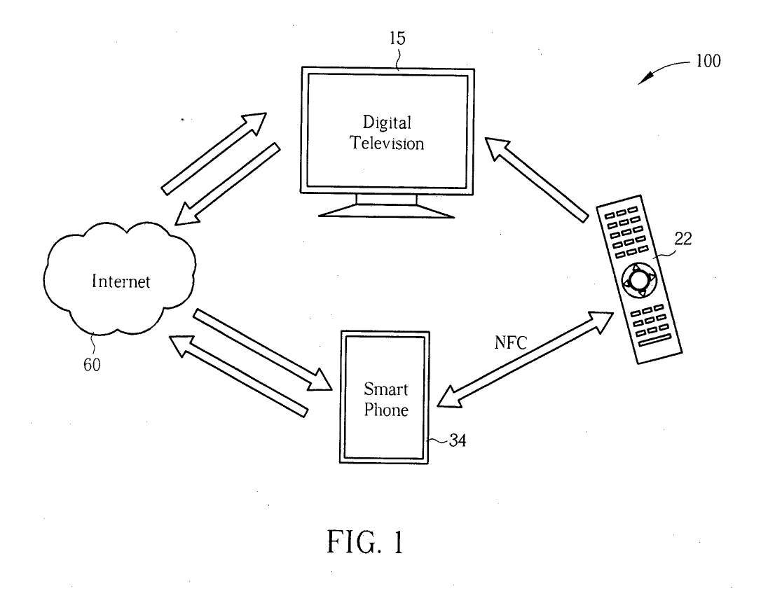

Please refer to FIG. 1, which illustrates a system 100 for an electronic device 15. The electronic device 15 in this embodiment is a digital television, but this is not a limitation of the invention. The digital television is operated by a remote control 22. A mobile phone 34 is also illustrated, wherein the mobile phone 34 and remote control 22 both have near field communication (NFC) capability. Near field communication is a very short range communication protocol, mainly used for authentication purposes: for example, a public transport card which can be used to pay for a bus or train ride. Therefore, in order for the mobile phone 34 and remote control 22 to communicate with each other, they must be brought very close to each other or must be touching. In this example, the mobile phone 34 is a smart phone, but this is merely one embodiment. Another mobile device such as a tablet could also be used. It should be noted that the remote control 34 may communicate with the digital television 15 via an infra-red communication or via a 2-way Bluetooth or Wi-Fi connection.

The NFC functionality between the mobile phone 34 and the remote control 22 enables a number of operations of the mobile phone 34 and the digital television 15. A first exemplary operation is described in the following.

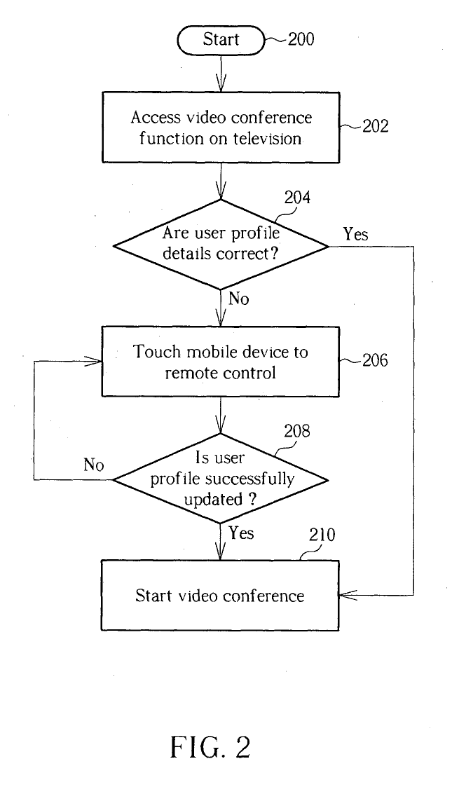

Please refer to FIG. 2, which is a flowchart showing steps of a method of the mobile phone 34 providing information to the digital television 15. In this example, a user wishes to access the video conference/Skype function of the digital television 15, and wishes to quickly access or update their profile without having to go through a lengthy authentication procedure. The steps of the method are as follows:

Step 200: Start;

Step 202: Access video conference function on television;

Step 204: Are user profile details correct? If yes, go to Step 210; if no, go to Step 206;

Step 206: Touch mobile device to remote control to transfer user details;

Step 208: Is user profile successfully updated? If yes, go to Step 210; if no, go back to Step 206;

Step 210: Start video conference application.

In the above method, by simply touching the mobile phone 34 to the remote control 22, a user's details can be passed to the remote control 22 using near field communication. The remote control 22 can then directly pass the details to the digital television 15 (via infra-red, Wi-Fi or Bluetooth, depending on the type of digital television) to directly update the user's profile. If a user has added new contacts or changed details in their profile on the mobile phone 34, they can directly transfer all this information to the digital television 15 merely by touching the mobile phone 34 to the remote control 22.

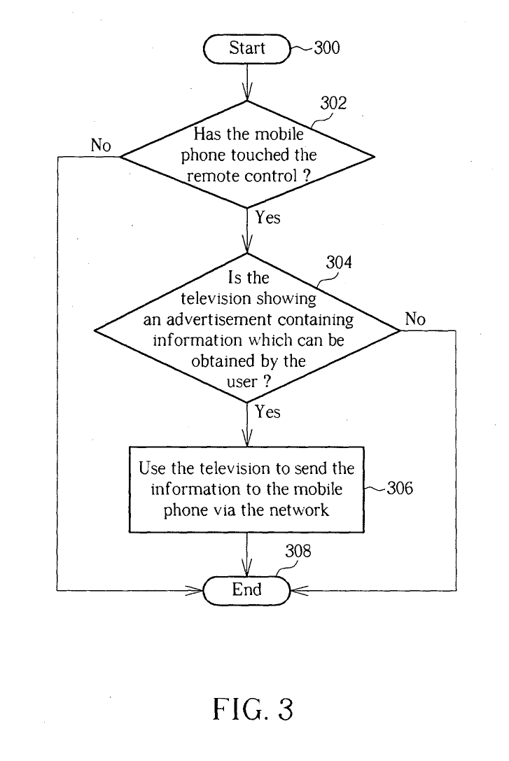

The system 100 can also enable information to be sent from the digital television 15 to the mobile phone 34. Please refer to FIG. 3, which illustrates steps of a method of performing the above operation. The steps are as follows

Step 300: Start;

Step 302: Has the mobile phone touched the remote control? If yes, go to Step 304; if no, go to Step 308;

Step 304: Is the television showing an advertisement containing information which can be obtained by the user? If yes, go to Step 306; if no, go to Step 308;

Step 306: Use the television to send the information to the mobile phone via the network;

Step 308: End.

The information sent through the network can be contained in a tag, created by the television. The above method can be used to realize a number of functions. If, for example, the advertisement were for a pizza delivery place, the tag created by the digital television could contain: a telephone number; a menu; a link to a website of the store, etc. When the mobile phone 34 is touched to the remote control 22, all the information in the tags can be retrieved. The data exchange and processing between the mobile phone 34 and the digital television 15 (via the remote control 22) is managed by a network application which resides in the cloud. This network application can handle various tasks such as passing on credit card details for enabling purchase of an item viewed by a user.

It is also possible for the remote control 22 to add information to the tags. In the method shown in FIG. 3, in Step 310 it is possible that no advertisement has been shown but there are tags already stored in the remote control. Tags can be created and sent to the remote control 22, and then retrieved when the digital television 15 is not in an active session. In this case, the remote control 22 may add information to the tags including, but not limited to, a time the tag was created, channel information of the tag, and a channel history prior to the tag being created.

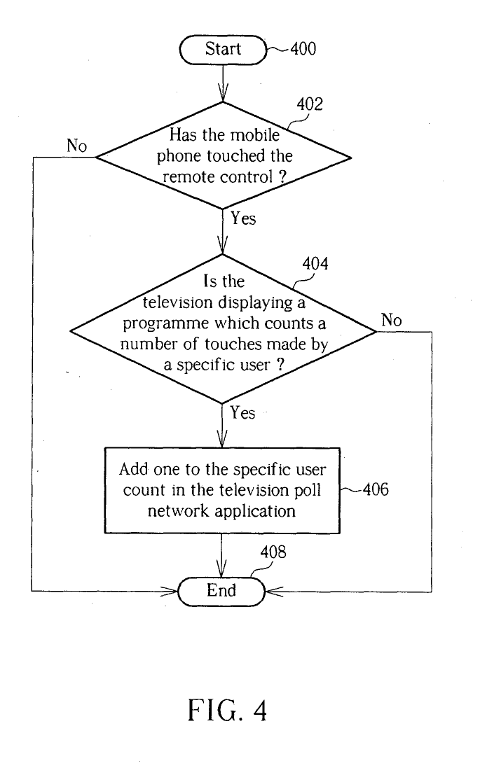

The detailed method of tailoring a digital television having a number of users to an individual user allows for reporting functions between the mobile phone 34 and the digital television 15, which allows a user to build up a viewing history. This function is illustrated in FIG. 4, which is a flowchart of steps of a method for enabling an interactive feature of a specific programme. The steps are as follows:

Step 400: Start;

Step 402: Has the mobile phone touched the remote control? If yes, go to Step 404; if no, go to Step 408;

Step 404: Is the television displaying a programme which counts a number of touches made by a specific user? If yes, go to Step 406; if no, go to Step 408;

Step 406: Add one to the specific user count in the television poll network application;

Step 408: End.

By using the authentication feature of the mobile phone 34 and remote control 22 communication, the television programme may only allow a viewer who has watched said programme a certain number of times to access interactive features of the programme. For example, many talent shows or competitions allow at-home viewers to vote, but require specific user details to ensure that only one vote per viewer is allowed. By using the remote control to mobile phone touch function, a user can quickly update their vote without entering a lengthy access procedure.

As noted, it is possible that the remote control 22 uses infra-red technology to communicate with the digital television 15, uses Bluetooth, or uses a Wi-Fi connection. When the remote control 22 is an infra-red remote control, communication must take place over a home network 60 for transmitting information, as the remote control 22 cannot transmit the information directly. It is also possible that the digital television 15 is connected to the network 60 or not connected to the network 60 when the mobile phone 34 and remote control 22 exchange information. In cases where the television 15 is not connected to the network 60 and the remote control 22 uses infra-red technology to communicate with the digital television 15, the remote control 22 may store previous information, such as the channel history of the digital television 15, so that this information can still be sent to the mobile phone 34 via NFC. In addition, more than one tag may be saved in the remote control 22, and the remote control 22 may add identifying information to the tags, such as time of day. It is further possible that the remote control 22 and mobile phone 34 be combined into one dedicated device.

The implementation of near field communication between a mobile device and a remote control of an electronic device allows the electronic device to be tailored to an individual user quickly and efficiently, making for a more interactive and fulfilling user experience. By utilizing a mobile device as a means for providing authentication, the system is also provided with a number of safety features. In addition, the functionality of both the electronic device and the mobile device can be integrated.

1. An interactive audio-visual system comprising:
an electronic device;
a remote control of the electronic device having Near Field Communication (NFC) tag capability;
a mobile device having NFC capability; and
at least a network application;
wherein an NFC interaction between the remote control and the mobile device initiates a data exchange via network between parts of the system.

2. The system of claim 1, wherein the remote control is an infra-red remote control.

3. The system of claim 1, wherein the remote control is a Bluetooth remote control.

4. The system of claim 1, wherein the remote control is a Wi-Fi remote control.

5. The system of claim 1, wherein the electronic device is a digital television with an internet connection.

6. The system of claim 1, wherein the electronic device is a device with an internet connection which streams video to a television.

7. The system of claim 1, wherein the mobile device is a smart phone.

8. The system of claim 1, wherein the mobile device is a tablet.

9. The system of claim 1, wherein after the NFC interaction between the remote control and the mobile device, the electronic device and the mobile device exchange information.

10. The system of claim 9, wherein at least one of the electronic device and the mobile phone sends the information to the network application.

11. The system of claim 10 wherein the network application can send information to the electronic device or the mobile device or both.

12. The system of claim 1 wherein the data exchanged is related to details of an advertisement presented by the electronic device.

13. The system of claim 1 wherein the data exchanged is related to details of a feature of the electronic device or the mobile device.

14. The system of claim 1 wherein the data exchanged is related to an application of the electronic device or the mobile device.

15. The system of claim 1 wherein the data exchanged is related to details of a payment request of the electronic device or the mobile device.
